(19) United States
(12) Patent Application Publication
(10) Pub. No.: US 2018/0276410 A1
(43) Pub. Date: Sep. 27, 2018

(54) System and Method for Providing Secure Access to Production Files in a Code Deployment Environment

(71) Applicant: O.C. Tanner Company, Salt Lake CIty, UT (US)

(72) Inventors: Trevor Forbes Linton, Salt Lake City, UT (US); Murray Lucas Resinski, Salt Lake City, UT (US); Michael Raymond Felix, Salt Lake City, UT (US); Cory Alexander Christopher, Salt Lake City, UT (US)

(21) Appl. No.: 15/465,331

(22) Filed: Mar. 21, 2017

(51) Int. Cl. G06F 21/62; G06F 17/30; G06F 9/445

(52) U.S. Cl. CPC G06F 21/6254; G06F 8/60; G06F 17/30887; G06F 21/6227

(57) ABSTRACT

A method for providing secure access to a production file in a code deployment environment is presented. The method includes receiving the production file comprising a plurality of configuration sections employed for one or more applications, wherein at least one of the configuration sections comprises at least one sensitive variable and at least one non-sensitive variable. Further, the method includes identifying the at least one sensitive variable in the at least one of the configuration sections based on an environment variable associated with the at least one sensitive variable. In addition, the method includes redacting the at least one identified sensitive variable in the at least one of the configuration sections to provide secure access to the production file.

### BACKGROUND

Embodiments of the present specification relate generally to a code deployment environment, and more particularly to a system and method for providing secure access to production files in the code deployment environment.

Typically, software applications are commonly developed under a collaborative effort by multiple code developers operating within a computing network. In general, the code developers (dev) build a source code in a code development environment. Further, the source code is provided to a production environment after testing and/or executing the source code by using one or more known methods or techniques. In the production environment, one or more operation (Ops) personnel convert the source code into a production file that is used for one or more applications by end-users. In addition, the operation personnel may add sensitive information, such as passwords, keys, tokens to the production file for authorizing the end-users. Once the production file with the sensitive information is deployed or released in the production environment, the code developers (dev) are locked out of the production file or the real product.

However, if the released production file includes bugs or feature requests are made, the production file is sent back to the code developers for making necessary changes to the code. This in turn allows the code developers who are unauthorized users to access or view the sensitive information in the production file. Thus, it is desirable to restrict/secure access to the sensitive information prior to sending the production file to the code developers.

In a conventional system, one or more operation (Ops) personnel may manually go through the production code and select all the sensitive information for which the operation personnel desires masking. Further, when a command is given, the selected sensitive information is masked in a copy of the production code. The problem with this approach is that the sensitive information need to be manually identified by the operation personnel in the production file, which is a hassle and time consuming process. Also, if the original production code is lost or destroyed, the information masked in the copy of the production code is permanently lost.

Thus, there is a need for an improved system and method for providing secure access to the production file in the code deployment environment.

### BRIEF DESCRIPTION

In accordance with aspects of the present specification, a method for providing secure access to a production file in a code deployment environment is presented. The method includes receiving the production file comprising a plurality of configuration sections employed for one or more applications, wherein at least one of the configuration sections comprises at least one sensitive variable and at least one non-sensitive variable. Further, the method includes identifying the at least one sensitive variable in the at least one of the configuration sections based on an environment variable associated with the at least one sensitive variable. In addition, the method includes redacting the at least one identified sensitive variable in the at least one of the configuration sections to provide secure access to the production file.

In accordance with another embodiment of the present specification, a production system for providing secure access to a production file in a code deployment environment is presented. The production system includes a repository unit configured to receive the production file comprising a plurality of configuration sections employed for one or more applications, wherein at least one of the configuration sections comprises at least one sensitive variable and at least one non-sensitive variable. Further, the production system includes a processor coupled to the repository unit and configured to identify the at least one sensitive variable in the at least one of the configuration sections based on an environment variable associated with the at least one sensitive variable, and redact the at least one identified sensitive variable in the at least one of the configuration sections to provide secure access to the production file.

In accordance with yet another embodiment of the present specification, a code deployment system for providing secure access to a production file is presented. The code deployment system includes a production server configured to receive the production file comprising a plurality of configuration sections employed for one or more applications, wherein at least one of the configuration sections comprises at least one sensitive variable and at least one non-sensitive variable. Also, the production server is configured to identify the at least one sensitive variable in the at least one of the configuration sections based on an environment variable associated with the at least one sensitive variable. Furthermore, the production server is configured to redact the at least one identified sensitive variable in the at least one of the configuration sections to provide secure access to the production file. In addition, the code deployment system includes a developer server configured to receive the production file from the production server, wherein the at least one identified sensitive variable is redacted in the at least one of the configuration sections of the production file. Further, the developer server is configured to access the at least one non-sensitive variable of the configuration sections of the production file.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical representation of a code deployment system for providing secure access to a production file in a code deployment environment, in accordance with aspects of the present specification;

FIG. 2 is a diagrammatical representation of a production environment in the code deployment environment, in accordance with aspects of the present specification; and

FIG. 3 is a flow chart illustrating a method for providing secure access to a production file in a code deployment environment, in accordance with aspects of the present specification.

### DETAILED DESCRIPTION

As will be described in detail hereinafter, various embodiments of systems and methods for providing secure access to a production file in a code deployment environment is presented. In particular, the systems and methods presented herein restricts unauthorized users from accessing or viewing sensitive information in the production file.

In the following specification and the claims, reference will be made to a number of terms, which shall be defined to have the following meanings. The singular forms “a”, “an”, and “the” include plural references unless the context clearly dictates otherwise.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the terms “software” and “firmware” are interchangeable, and include any computer program stored in memory for execution by devices that include, without limitation, mobile devices, clusters, personal computers, workstations, clients, and servers.

As used herein, the term “computer” and related terms, e.g., “computing device”, are not limited to integrated circuits referred to in the art as a computer, but broadly refers to at least one microcontroller, microcomputer, programmable logic controller (PLC), application specific integrated circuit, and other programmable circuits, and these terms are used interchangeably herein.

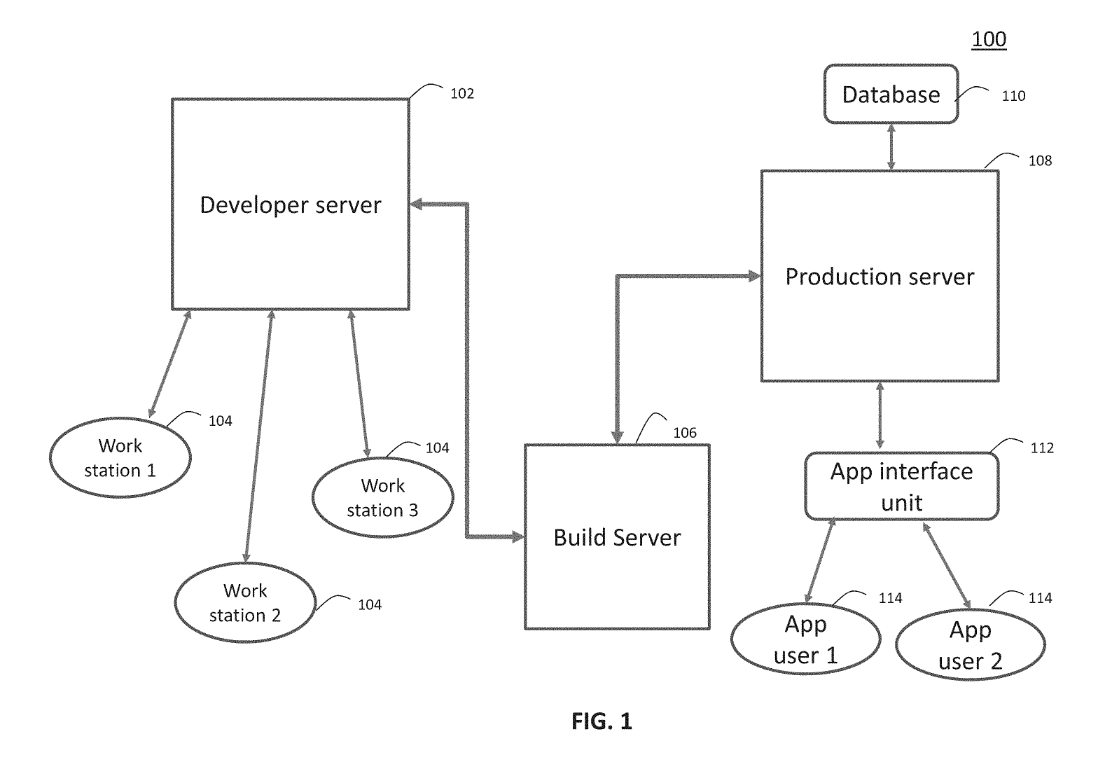

FIG. 1 is a diagrammatical representation of a code deployment system 100 in a code deployment environment for providing secure access to a production file, in accordance with aspects of the present specification. The code deployment environment includes a development environment, a build environment, and a production environment. It may be noted that the code deployment environment may include other environments, and are not limited to the environments depicted in FIG. 1. Also, it may be noted that these environments may be referred by other similar terminology.

In a presently contemplated configuration, the development environment is a working environment where software applications are commonly developed under a collaborative effort by multiple code developers operating within a computing network. More specifically, the development environment includes a developer server 102 that is communicatively coupled to a plurality of workstations 104. In one example, the developer server and the plurality of workstations 104 may be any computer device that can execute computer-readable instructions to perform one or more functions.

Further, the code developers may use these workstations 104 to build one or more code portions in their corresponding workstation 104. Thereafter, these code portions may be integrated and validated in the developer server 102 to form a source code. It may be noted that the source code may be built using one or more programming languages. In one example, the source code may include one or more configuration sections that are used for applications by end-users. In the development environment, these configuration sections may include only non-sensitive variables/data. In one embodiment, the development environment may include code development tools, such as compliers, integrators, libraries, and support software for building and validating the source code. Also, the code developers may use these tools to make radical changes to the source code without adversely affecting other environments in the system.

Upon building the source code, the developer server 102 may communicate the source to a build environment to convert the source code to an executable code. Particularly, the build environment includes a build server 106 that is configured to perform different testing on the source code. In one embodiment, one or more quality assurance (QA) testers may review and execute the source code to detect bugs in the source code. Further, the QA testers may send QA reports to the code developers to fix the detected bugs in the source code. Also, the build environment may include a staging environment that is identical to the production environment. The staging environment may be used for other testing, such as performance testing, load testing, or the like. After fixing all the bugs in the source code, the source code is copied as an executable code in the build server 106. Further, the build server 106 may communicate this executable code to the production environment.

Furthermore, the production environment may be a network of many geographically distributed machines in data centers or virtual machines in cloud computing. In the embodiment of FIG. 1, the production environment includes a production server 108, a database 110, and an App interface unit 112 that is coupled to a plurality of App user devices, such as a first App user device 114 and a second App user device 114. In one example, the App user devices 114 may include laptops, mobile phones, distributed machines, virtual machines, or the like. Similarly, the App interface unit 112 may be a device or the cloud computing network. In one example, the production environment may include other components/devices, and are not limited to the devices mentioned in FIG. 1. Also, these devices/components may be any computer device that can execute computer-readable instructions to perform one or more functions.

The production server 108 may be configured to convert the executable code into a production file that may be used for one or more applications by the end-users. More specifically, operation personnel (Ops) may identify different configuration sections in the executable code where sensitive variables may be added into the executable code. In one example, the sensitive variables may include sensitive information, such as passwords, keys, tokens, or the like. These sensitive variables may be used to authorize the end-users prior to providing application service to the end-users. Also, the operational personnel may tag these configuration sections with a predefined tag. For example, the configuration sections having the sensitive variables are associated with a SOC tag/flag. Moreover, the executable code with the sensitive variables and the non-sensitive variables are copied into the database as a production file. Further, the production file may be deployed or released in the production environment for the end-users to use the applications corresponding to the production file.

Moreover, once the production file with the sensitive variables/information is deployed or released in the production environment, the code developers (dev) are locked out of the production file or a real product. However, if the released production file includes new bugs and/or feature requests are made, the production file may be sent back to the development environment to make necessary changes. As the production file is sent to the development environment, any unauthorized users, such as the code developers may access or view the sensitive variables/information in the production file.

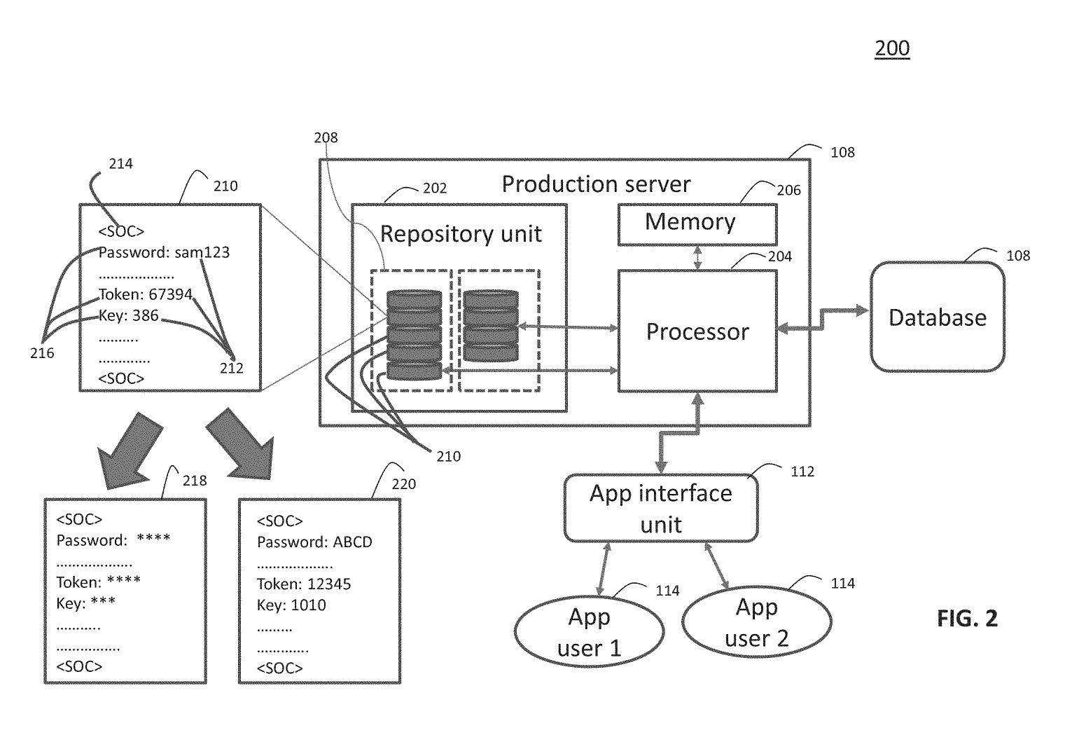

To overcome the above problems/shortcomings, the exemplary production server 108 is configured to secure these sensitive variables in the production file prior to providing access to the production file in the code deployment environment. In particular, the exemplary production server 108 is configured to redact the sensitive variables in the production file prior to sending the production file to the developer server 102. In one example, the production server 108 may copy the production file in the database. Further, when a redacted command is received from the operation personnel, the production server 108 may create a redacted version of the production file by replacing the sensitive variables with one or more predefined characters, words, and/or strings. Due to this redaction of the file, the unauthorized users are unable to comprehend any redacted portion of the production file. Thereafter, the redacted version of the production file may be transmitted to the code deployment environment. In one embodiment, a web link is provided to the unauthorized users, such as the code developers for providing access only to the non-sensitive variables of the production file. In one example, one-time access may be provided to these unauthorized users. The aspect of redacting the sensitive variables in the production file is explained in greater detail with reference to FIG. 2.

At the development environment, the code developers make necessary changes to the non-sensitive variables in the production file to fix the new bugs and/or add new features to the production file. As the sensitive variables in the production file are redacted, the code developers are restricted to view or access the sensitive variables in the production file. Further, the production file may be sent to the build environment to undergo one or more testing, and thereafter the production file is again deployed or released in the production environment. In one embodiment, a new version of the production file may be released or a portion of the production file where the changes are made may be released in the production environment. It may be noted that the production file may be released in one more methods, and is not limited to the method mentioned herein.

Thus, by employing the exemplary code deployment system, particularly, the production server 108, the production file may be secured from the unauthorized users. Also, the changes in the production file are made without accessing the sensitive variables in the production file. Moreover, the changes are made only to the redacted version of the production file, and thus the sensitive information is not permanently lost in the production environment.

Referring to FIG. 2, a diagrammatical representation of a production environment 200 having a production server 108 for providing secure access to a production file 208, in accordance with aspects of the present specification is depicted. The production server 108 includes a repository unit 202, a processor 204, and a memory 206. Also, the production server 108 is communicatively coupled to one or more App user devices 114 via the App interfacing unit 112. The App user devices 114 may use the production file 208 in the production server for one or more applications. Also, the database 108 may be used to store a copy of the production file 108 that may be used for other applications in the later stage. It may be noted that the terms “production server” and “production system” may be used interchangeably in the below specification.

In the exemplary embodiment, the processor 204 may be configured to store the executable code received from the build server 106 in the repository unit 202. Also, the processor 204 may convert the executable code to a production file 208 having one or more configuration sections 210. These configuration sections 210 are used by end-users for one or more applications. Also, the processor 204 may add sensitive variables 212 along with the existing non-sensitive variables in the configuration sections 210 of the production file. The sensitive variables 212 may include sensitive information such as, passwords, keys, tokens, URI spec. having password, or the like. It may be noted that the sensitive variables 212 may include other types of sensitive information, and is not limited to the information mentioned herein. In one embodiment, the processor 204 may add one or more pointers to the locations or fields in the production file 208 where the sensitive variables 212 are added. Also, these pointers are maintained in a table in the repository unit 202. Further, the processor 204 may associate the configuration sections 210 having the sensitive variables 212 with a predefined tag 214. In one example, the configuration sections 210 having the sensitive variables 212 are associated with a SOC tag 214.

During operation, the processor 204 may receive a redact command from the operation personnel to redact sensitive variables 212 in the production file 208. In one example, if the released production file 208 includes new bugs and/or feature requests are made, the operation personnel may decide to send the production file 208 back to the development environment to make necessary changes. However, prior to sending the production file 208, the operation personnel may send the redact command to the processor 204 to secure the sensitive variables in the production file 208.

In response to receiving the redact command, the processor 204 may execute one or more instructions stored in the memory 206 to run a program for redacting the sensitive variables 212 in the production file 208. It may be noted that, these instructions may be stored in one or more programming languages in the memory 206. Also, the program may be executed based on one or more policies that are predetermined for redacting the production file 208 and/or other data in the production environment. In one embodiment, these policies may be stored along with the production file 208 in the repository unit 202. Also, these policies may be customized based on one or more data security requirements in the production environment. In one example, the processor 204 may automatically execute the instructions stored in the memory 206 in real-time.

Further, when the redact command is received from the operation personnel, the processor 204 conducts a search in the production file 208 to select one or more configuration sections 210 that are associated with the predefined tag, e.g., SOC tag 214. Thereafter, the processor 204 may conduct another search in each of the selected configuration sections 210 to identify the sensitive variables 212 in the configuration sections 210. In one embodiment, the processor 204 may conduct a search to locate one or more environment variables 216 in the selected configuration sections 210. The environment variables 216 may be referred to as predefined words or strings that are positioned adjacent or proximate to the sensitive variables. In one example, the environment variables 216 may include predefined words or strings, such as “password,” “key,” secret, private, and “token,” pass, or the like. In another embodiment, the processor 204 may use the pointers associated with the sensitive variables 212 to locate the sensitive variables in the production file 208.

Upon locating the environment variables 216 in the configuration sections 210, the processor 204 may redact the sensitive variables 212 proximate or adjacent to the environment variables 216 so that an unauthorized user is ceased from accessing the sensitive variables 212 in the production file 208. In one example, the unauthorized user may include code developers who are locked out of the production file 208 or the final product. In one example, the processor 204 may redact the sensitive variables 212 by replacing the sensitive variables 212 with one or more predefined characters, such as asterisk. This type of redacted production file is represented by a reference numeral 218 in FIG. 2. In another example, the processor 204 may redact the sensitive variables 212 by replacing the sensitive variables 212 with one or more non-sensitive words, numbers, or strings that are pre-stored in the repository unit 202. This type of redacted production file is represented by a reference numeral 220 in FIG. 2.

After redacting the sensitive variables 212 in the production file 208, the processor 204 may send the production file 208 to the developer server 102 where the code developers may work on the production file 208 without accessing or viewing the sensitive information/variables in the production file 208. In one embodiment, the processor 204 may send a web link to the developer server 102 for providing access to the redacted production file in the production server 108. In another embodiment, the processor 204 may provide one-time access to the redacted production file to the unauthorized users, such as the code developers. At the development environment, the code developers make necessary changes to the non-sensitive variables in the production file to fix the new bugs and/or add new features to the production file. Further, the production file may be sent to the build environment to undergo one or more testing, and thereafter the production file is again deployed or released in the production environment.

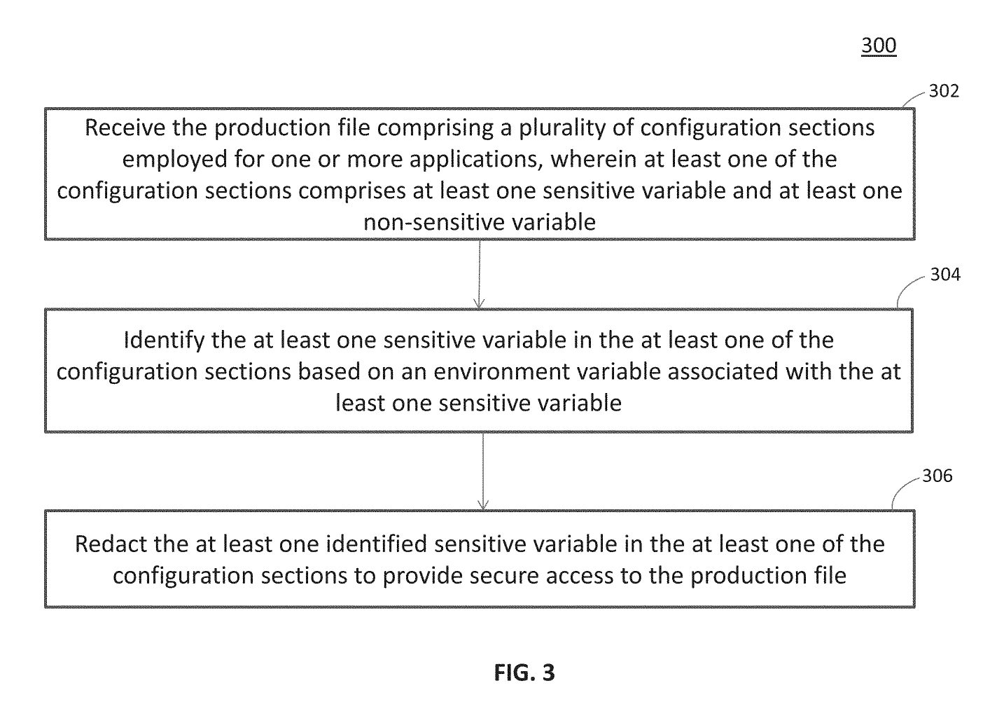

FIG. 3 is a flow chart illustrating a method 300 for providing secure access to a production file in a code deployment environment, in accordance with aspects of the present specification. For ease of understanding, the method 300 is described with reference to the components of FIGS. 1 and 2. The method 300 begins with a step 302, where a production file 208 including a plurality of configuration sections 210 employed for one or more applications is received. To that end, a production server 108 in the code deployment system receives the production file 208 from the database 108. The configuration sections 210 may include one or more sensitive variables 212 and one or more non-sensitive variables.

Subsequently, at step 304, the at least one sensitive variable 212 in the at least one of the configuration sections 210 is identified based on an environment variable 216 associated with the at least one sensitive variable 212. In particular, the processor 204 may conduct a search to locate one or more environment variables 216 in the selected configuration sections 210. The environment variables 216 may be referred to as predefined words, numbers, or strings that are positioned adjacent or proximate to the sensitive variables 212. In one example, the environment variables 216 may include predefined words or strings, such as “password,” “key,” and “token,” or the like.

In addition, at step 306, the at least one identified sensitive variable 212 in the at least one of the configuration sections 210 is redacted to provide secure access to the production file 208. More specifically, the processor 204 may redact the sensitive variables 212 by replacing the sensitive variables 212 with one or more predefined characters, numbers, words, and/or strings. After redacting the sensitive variables 212 in the production file 208, the processor 204 may send the production file 208 to the developer server 102, where the code developers may work on the production file without accessing or viewing the sensitive information/variables in the production file.

The various embodiments of the exemplary systems and methods presented hereinabove aid in providing secure access to the production file in a code deployment environment. In particular, the systems and methods presented herein restricts unauthorized users from accessing or viewing sensitive information in the production file. Moreover, the production file is redacted in a real-time without persistently altering the actual data in the production file.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

While the technology has been described in detail in connection with only a limited number of implementations, it should be readily understood that the invention is not limited to such disclosed implementations. Rather, the technology can be modified to incorporate any number of variations, alterations, substitutions or equivalent arrangements not heretofore described, but which are commensurate with the spirit and scope of the disclosure. Additionally, while various implementations of the technology have been described, it is to be understood that aspects of the technology may include only some of the described implementations. Accordingly, the inventions are not to be seen as limited by the foregoing description, but are only limited by the scope of the appended claims.

1. A method for providing secure access to a production file in a code deployment environment, the method comprising:
receiving the production file comprising a plurality of configuration sections employed for one or more applications, wherein at least one of the configuration sections comprises at least one sensitive variable and at least one non-sensitive variable;
identifying the at least one sensitive variable in the at least one of the configuration sections based on an environment variable associated with the at least one sensitive variable; and
redacting the at least one identified sensitive variable in the at least one of the configuration sections to provide secure access to the production file.

2. The method of claim 1, wherein redacting the at least one identified sensitive variable comprises replacing the at least one identified sensitive variable with one or more predefined characters.

3. The method of claim 1, wherein redacting the at least one identified sensitive variable comprises replacing the at least one identified sensitive variable with one or more non-sensitive words.

4. The method of claim 1, wherein identifying the at least one sensitive variable comprises:
determining that the at least one of the configuration sections is associated with a predefined tag; and
locating the at least one environment variable proximate to at least one sensitive variable in the at least one of the configuration sections.

5. The method of claim 4, further comprising masking the at least one sensitive variable proximate to the at least one environment variable so that an unauthorized user is ceased from accessing the at least one sensitive variable in the production file.

6. The method of claim 5, further comprising providing a web link of the production file to the unauthorized user to gain access only to the at least one non-sensitive variable of the production file.

7. The method of claim 6, further comprising providing one-time access to the production file via the web link.

8. The method of claim 1, wherein the at least one environment variable comprises pass, key, secret, private, and token.

9. The method of claim 1, wherein the at least one environment variable comprises a password portion of a resource identifier.

10. The method of claim 1, wherein the at least one identified sensitive variable in the at least one of the configuration sections is redacted before providing access to the production file.

11. A production system for providing secure access to a production file in a code deployment environment, the production system comprising:
a repository unit configured to receive the production file comprising a plurality of configuration sections employed for one or more applications, wherein at least one of the configuration sections comprises at least one sensitive variable and at least one non-sensitive variable;
a processor coupled to the repository unit and configured to:
identify the at least one sensitive variable in the at least one of the configuration sections based on an environment variable associated with the at least one sensitive variable; and
redact the at least one identified sensitive variable in the at least one of the configuration sections to provide secure access to the production file.

12. The production system of claim 11, wherein the processor is configured to replace the at least one identified sensitive variable with one or more predefined characters.

13. The production system of claim 11, wherein the processor is configured to replace the at least one identified sensitive variable with one or more non-sensitive words.

14. The production system of claim 11, wherein the processor is configured to:
determine that the at least one of the configuration sections is associated with a predefined tag; and
locate the at least one environment variable proximate to at least one sensitive variable in the at least one of the configuration sections.

15. The production system of claim 14, wherein the processor is configured to mask the at least one sensitive variable proximate to the at least one environment variable so that an unauthorized user is ceased from accessing the at least one sensitive variable in the production file.

16. The production system of claim 15, wherein the processor is configured to provide a web link of the production file to the unauthorized user to gain access only to the at least one non-sensitive variable of the production file.

17. The production system of claim 16, wherein the processor is configured to provide one-time access to the production file via the web link.

18. A code deployment system for providing secure access to a production file, the code deployment system comprising:
a production server configured to:
receive the production file comprising a plurality of configuration sections employed for one or more applications, wherein at least one of the configuration sections comprises at least one sensitive variable and at least one non-sensitive variable;
identify the at least one sensitive variable in the at least one of the configuration sections based on an environment variable associated with the at least one sensitive variable; and
redact the at least one identified sensitive variable in the at least one of the configuration sections to provide secure access to the production file;
a developer server configured to:
receive the production file from the production server, wherein the at least one identified sensitive variable is redacted in the at least one of the configuration sections of the production file; and
access the at least one non-sensitive variable of the configuration sections of the production file.

19. The code deployment system of claim 18, wherein the developer server receives a one-time access web link to gain access to the non-sensitive variable of the configuration sections of the production file.

20. The code deployment system of claim 18, wherein the production server is configured to redact the at least one identified sensitive variable in the at least one of the configuration sections by replacing the at least one identified sensitive variable with one or more predefined characters or non-sensitive words.
